(19) United States
(12) Patent Application Publication
(10) Pub. No.: US 2025/0222645 A1
(43) Pub. Date: Jul. 10, 2025

(54) Method for regulating a heating unit in a facility for producing containers

(71) Applicant: SIDEL PARTICIPATIONS, OCTEVILLE-SUR-MER (FR)

(72) Inventors: Julien GENDRE, OCTEVILLE-SUR-MER (FR); Pierrick PROTAIS, OCTEVILLE-SUR-MER (FR); Arnaud DELAUNAY, OCTEVILLE-SUR-MER (FR)

(21) Appl. No.: 18/724,417

(22) PCT Filed: Dec. 27, 2022
(86) PCT No.: PCT/EP2022/087891

§ 371 Date: Jun. 26, 2024

(30) Foreign Application Priority Data
Dec. 30, 2021 (FR) FR2114703

(51) Int. Cl. B29C 49/78; B29C 49/64

(52) U.S. Cl. CPC B29C 49/786; B29C 49/6418; B29C 2049/7861; B29C 2049/787

(57) ABSTRACT

A method for producing containers made of thermoplastic material from preforms. In example embodiments, the method includes comparing a thickness measurement with a stored thickness setpoint, by use of a control unit, and modifying an electrical power of at least two rows of radiation sources while keeping the sum of the electrical powers being supplied to all rows of radiation sources the same, by use of the control unit, if the measured thickness is different from the thickness setpoint. A computer program product and data processing device using the method is also disclosed.

### CROSS-REFERENCE TO RELATED APPLICATION

This application claims priority to Patent Cooperation Treaty Patent Application No. PCT/EP2022/087891 filed Dec. 27, 2022, which claims priority to French Patent Application Serial No. 2114703 filed Dec. 30, 2021, the entirety of which is incorporated herein by reference.

### TECHNICAL FIELD OF THE INVENTION

The invention relates to the field of the manufacture of containers (in particular bottles, flasks) by molding from preforms made of plastics material, such as for example polyethylene terephthalate (PET).

The manufacture of such containers is carried out in a facility comprising a heating unit and a molding unit, provided with a succession of molds with a cavity in the shape of the type of container to be molded and corresponding injection devices.

The manufacture comprises two principal phases, namely a phase of heating the preforms, during which a succession of preforms is heated to a reference temperature at which the preforms are in a malleable state in which they can be molded, and a molding phase during which the heated preforms are each transferred into a mold of the blowing station 8 and a pressurized fluid is injected into each preform by the corresponding injection device, also called the nozzle, to provide the preform with the final shape of the container. The pressurized fluid is for example a gas, such as air. The molding generally includes a stretching phase which is implemented by means of a mobile stretch rod 13 which is arranged to apply a stretching force on the base of a preform in a mold in order to stretch the preform along its axis, which helps to keep the preform centered relative to the mold.

Moreover, a production facility generally comprises a control console from which numerous parameters can be adjusted manually in the heating unit, for example: the heating temperature, the machine rate which modifies the running speed of the preforms, the power of a ventilation system ensuring the removal of part of the heat;

This operation is tedious and time-consuming to implement and requires the presence of an operator having a good knowledge of the production facility and the types of preform capable of being introduced into the facility in order to obtain a container with a good distribution of material over its entire height corresponding to the specification of the client.

### PRIOR ART

In order to remedy this drawback, the European patent EP 1998950 (KHS) describes a production facility which comprises a method for regulating the heating parameters of the oven, in particular for regulating variations in the electrical power of the radiation sources as a function of the thickness of the wall of the molded container.

However, this modification of the heating parameters of the oven can lead to a modification of the thermal conditioning of the preform during production and thus produce a non-conformity of the molded container relative to the specification of the client. Moreover, the non-conformity of the molded container increases the manufacturing costs and can require the facility to be shut down, which increases the manufacturing costs even further.

### SUMMARY OF THE INVENTION

The invention aims to provide a real practical solution to the problem set forth above, by proposing a method making it possible to modify the thermal conditioning of the preforms, on the one hand, without being obliged to shut down the production facility and, on the other hand, maintaining the quality of the containers produced during the production of the containers.

To this end, in the first instance a method is proposed for producing containers made of thermoplastic material from preforms which defines a path for circulating the preforms and the containers, which comprises:
a molding unit for molding containers having a vertical axis comprising at least one blowing station, each including a mold with a cavity in the shape of a container and a device for injecting a pressurized fluid into the preform;
a heating unit for heating preforms which is located on the circulation path upstream of the molding unit relative to the direction of circulation of the preforms, comprising:
a means for conveying the preforms comprising a plurality of individual supports for the preforms defining a path for heating the preforms;
a heating cavity comprising two lateral walls that face one another and are at a distance from one another, at least one of said walls being that which bears a plurality of radiation sources arranged one above the other and side by side facing the preforms, thereby forming a row of radiation sources relative to the path for heating the preforms;
an electrical power supply, supplying each radiation source with electrical power;
a control unit connected to the electrical power supply, said control unit having a memory for storing:
at least one electrical power setpoint for at least one row of radiation sources;
at least one thickness setpoint in at least one point of the container;
the control unit carrying out at least one measurement of the thickness of a wall of the container at at least one point of the container by means of at least one sensor;

The control unit compares the thickness measurement with the stored thickness setpoint and if the measured thickness is different from the thickness setpoint, then the control unit modifies the electrical power of at least two rows of radiation sources while keeping the sum of the electrical powers being supplied to all of the rows of radiation sources the same.

According to the further steps of the production method according to the invention, the control unit:
modifies said electrical power of at least two rows of radiation sources in a homogenous manner;
increases the electrical power on one row by a specific value, and then the control unit reduces the electrical power on the remaining rows by the specific value, divided by the number of remaining rows;
reduces the electrical power on one row by a specific value, and then the control unit increases the electrical power on the remaining rows by the specific value, divided by the number of remaining rows;

On one row of radiation sources, if at least one radiation source operates at its maximum electrical power and if at least one radiation source is switched off on the same row, then the control unit switches on one of the radiation sources which has been switched off and reduces the electrical power of each radiation source of the row, while keeping the sum of the electrical powers being supplied to the row of radiation sources constant;

If at least one radiation source operates at a “minimum effective” electrical power, then the control unit switches off one of the radiation sources and increases the electrical power of each radiation source of the row, while keeping the sum of the electrical powers being supplied to the row of radiation sources constant.

According to further features of the production method according to the invention, the radiation sources are:
halogen lamps emitting in the infrared range;
laser diodes emitting in the infrared range;

In the second instance, a computer program product is proposed, comprising a sequence of instructions which, when the program is executed by a computer, results in the computer implementing the steps of the method.

In the third instance, a data processing device is proposed, comprising means for implementing the steps of the method.

### BRIEF DESCRIPTION OF THE FIGURES

Further features and advantages of the invention will become apparent by reading the following detailed description and for the understanding thereof reference will be made to the accompanying drawings which will be briefly described hereinafter.

FIG. 1 is a general top view of a production facility

FIG. 2 is a schematic side view of a heating unit and a blowing station 8;

FIG. 3 is a schematic configuration of a heating unit showing the state of the radiation sources.

### DETAILED DESCRIPTION OF THE INVENTION

In the remainder of the description, elements which have an identical structure or similar functions will be denoted by the same reference sign.

Facilities for the mass production of containers 4 made of thermoplastic material from preforms 2 are schematically shown in the figures.

In the remainder of the description, the preforms 2 and the containers 4 are displaced in the production facility along a circulation path from upstream to downstream. The preforms 2 are displaced in a row along a heating path by conveying means which will be detailed hereinafter.

In a non-limiting manner, in this case the containers 4 are bottles. The thermoplastic material is, for example, formed here by polyethylene terephthalate, denoted hereinafter by its acronym “PET”.

An example of such a preform 2 has been shown in the figure. The preform 2 has a principal axis “X”, shown vertically in the figure. The preform has a cylindrical body 5 with a tubular wall which is closed at one of its axial ends by a base 3 and which is open at its other end by a neck 7 which is also tubular. The neck 7 has a flange 9 at its base, serving for the transport thereof in the production facility.

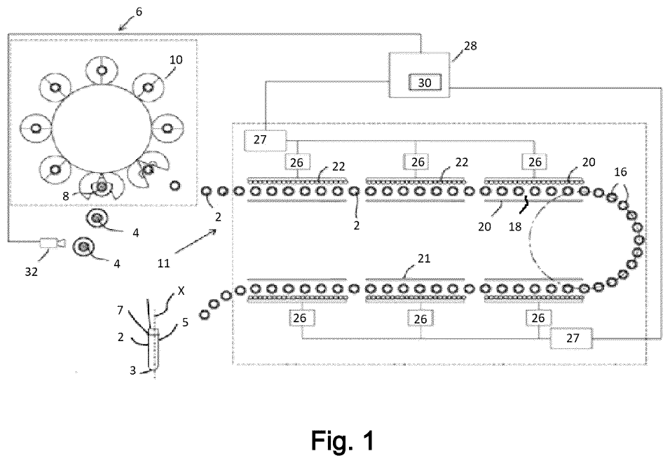

As shown in detail in FIG. 1, the wall is delimited by an external face and by an internal face. The neck 7 generally has its definitive shape, while the body 5 of the preform 2 is designed to be subjected to a relatively large deformation in order to mold the final container 4 during a molding step.

As shown in FIG. 1, the production facility comprises at least one molding unit 6, a heating unit 11, and a control unit 28 of the production facility, which comprises in particular a computer (or processor), a memory 30 and a console (or graphic interface), not shown, for interaction with an operator.

The molding unit 6 for molding containers 4 is formed by a molding wheel displacing a plurality of molding stations in rotation from an inlet to an outlet, at which a succession of containers 4 molded from the preforms 2 is extracted, as shown in FIG. 1. The axis of rotation of the molding wheel is, for example, substantially parallel to the principal axis X of the preforms when they are transported by the molding wheel.

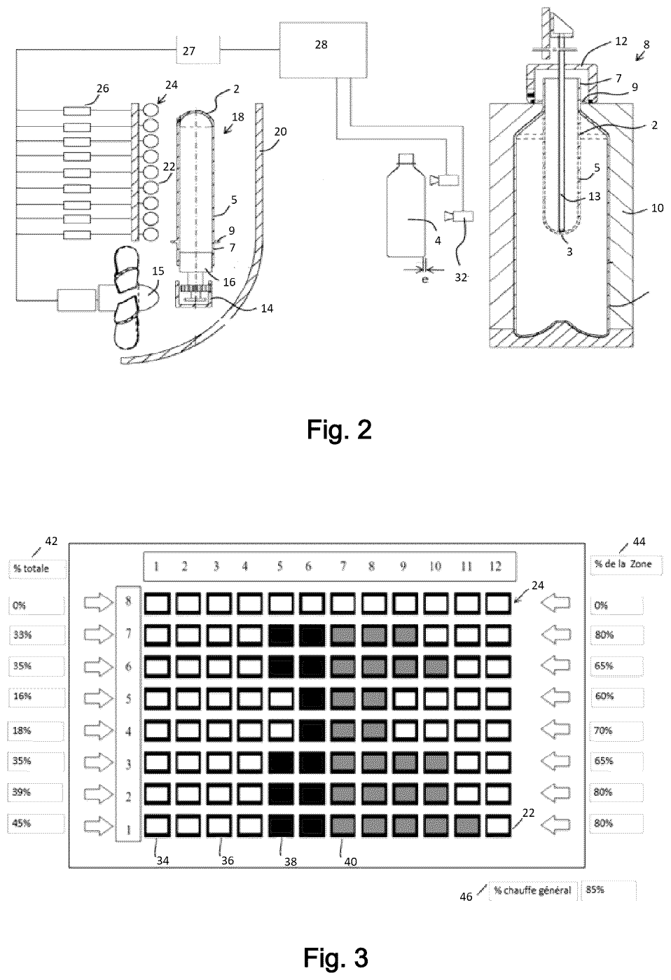

Each blowing station 8 comprises a mold 10 forming a mold cavity having the shape of the container 4 to be molded and arranged to receive a preform 2 so that the body 5 of the preform extends in the mold cavity, as shown in FIG. 2. Each mold 10 is formed from a plurality of parts which are mobile between an open position in which the mold 10 can receive a preform and release a container 4, respectively at the inlet and the outlet, and a closed position in which the mold cavity is closed onto the preform between the inlet and the outlet.

When a preform is received in the mold 10, the body 5 extends in the mold cavity and the neck 7 protrudes from the mold 10 outside the mold cavity, as shown in FIG. 2.

Each blowing station 8 also comprises an injection device 12 which is arranged to inject a fluid into the internal volume of the preform placed into the mold 10 of the blowing station 8 such that the fluid deforms the preform and said preform acquires the shape of the mold cavity, i.e. the preform 2 is molded into a container 4 by the action of the fluid. According to one embodiment, the fluid is for example a pressurized gas, for example pressurized air. In this case, the injection device 12 is formed by a nozzle and by one or more valves enabling the injection of fluid into the preform 2 to be controlled. The pressure at which the fluid is injected can be regulated. By way of example and in the known manner, the molding facility comprises an air reservoir which is pressurized to a first pressure, and a further air reservoir which is pressurized to a second pressure, the valves enabling the air to be injected selectively at the first pressure or at the second pressure.

According to one embodiment, shown in FIG. 2, each blowing station 8 also comprises a stretch rod 13 which is mobile relative to the mold 10 in a direction coinciding with the principal axis X of the preform 2 when it is placed in the mold 10. The stretch rod 13 is arranged to bear against the base 3 of the preform in order to stretch said preform in the axial direction. More particularly, the stretch rod 13 extends the preform until the base 3 of the preform comes into contact with the base of the mold cavity. The displacement of the stretch rod 13 is controlled by an actuator, either a mechanical actuator of the hydraulic cylinder type controlled by a cam and roller system, or by an electric actuator of the linear motor type.

The molding unit 6 is controlled automatically by a control unit 28.

The heating unit 11, also called the oven, enables a succession of preforms 2 to be heated to a reference temperature, after it has been set up, as will be described below. The reference temperature is selected such that the body 5 of each preform 2 at the outlet of the heating unit 11 is in a malleable state, enabling a deformation of the body 5 of the heated preform in order to mold the container 4 in the molding unit 6. The reference temperature is between the glass transition temperature and the crystallization temperature of the plastics material of the preform 2. In the case of PET, the reference temperature is, for example, in the region of 110°. The value of the reference temperature can vary as a function of the product which will be filled into the container 4 or as a function of the technique of filling the container. Thus the reference temperature is different for hot-filling or for a carbonated product, for example. It will be noted that the reference temperature corresponds to the temperature at a reference point of the preform 2, i.e. in a localized zone. More specifically, the preform is not necessarily heated to a uniform temperature but can have a temperature profile causing the temperature of the preform to vary over its height as a function of the desired distribution of material in the region of the container 4.

According to the embodiment shown in FIG. 1, the heating unit 11 is a continuous oven in which the preforms are transported in order to be exposed to a plurality of heat radiation sources 22. To this end, the heating unit 11 comprises a means 14 for conveying the preforms 2 through the heating unit 11 along a heating path extending between an inlet and an outlet of the heating unit 11.

As shown in FIGS. 1 and 2, the conveying means 14 comprises a succession of supports 16, each being capable of supporting a preform 2, mounted on a chain conveyor and being displaced along the heating path in the heating unit 11.

In a further embodiment, not shown, the means 14 for conveying comprises, for example, a succession of supports 16, each being capable of supporting a preform, mounted on a linear motor-type carriage which circulates on a closed magnetic loop. The movement of each of the these carriages is controlled independently of one another by the control unit 28.

Each support 16 is capable of receiving a preform 2, for example, by the neck being fitted onto the support 16, as shown in FIG. 2. Each support 16 is, for example, mobile in rotation relative to the chain conveyor about an axis of rotation which coincides with the principal axis X of a preform 2 when this preform is supported by the support 16. The radiation heat sources 22 are distributed in the manner of a matrix (as shown in FIG. 3) along the heating path and in a transverse direction relative to the path, the transverse direction being substantially parallel to the principal axis X of the preforms when the preforms are supported by the supports 16.

The heating unit 11 also comprises a heating cavity 18 comprising two lateral walls 20 that face one another and are at a distance from one another, and at least one of said walls 20 is that which bears a plurality of radiation sources 22 arranged one above the other and side by side facing the preforms, thereby forming a row 24 of radiation sources 22 relative to the path for heating the preforms.

In other words, the heating unit 11 comprises a plurality of radiation sources 22 distributed along the heating path and along a height of the preform such that the entire height of the body 5 of each preform is exposed to the radiation sources 22 on the path of the preform in the heating unit 11. By rotating the preforms about their principal axis X, the supports 16 enable the entire body 5 of the preforms to be exposed uniformly to the radiation sources 22. The radiation sources 22 can be distributed on one side only of this path, in which case a reflective wall 21 can be arranged on the other side of the heating path in order to reflect the heat toward the preforms.

In a further embodiment, not shown, the radiation sources 22 can be distributed on either side of the heating path.

It should be noted that the radiation sources 22 are arranged, if required, to apply radiation to the body 5 of the preform 2, thus defining an appropriate temperature profile through the wall of the preform from the outside to the inside. It can be assumed in principle that areas of the preform having a lower temperature result in thicker walls of the molded container 4, while hotter areas of the preform are more stretched during the blowing operation and thus result in a thinner wall of the container 4.

It should also be noted that the radiation sources 22 are arranged, if required, so as not to apply the heat emitted by the radiation sources 22 to the neck 7 and the ring. More specifically, as indicated above, only the body 5 of the preform is molded to produce the container 4. As a result, the neck 7 and the ring do not have to be deformed during the molding process and do not have to be heated. In order to avoid heating the neck 7 and the ring, the heating unit 11 can comprise a ventilation device which is positioned perpendicularly to the necks and rings in order to remove the heat which is likely to be absorbed by the necks and the rings. The ventilation device comprises, for example, at least one fan 15 controlled by the control unit 28.

Each radiation source 22 is formed by an incandescent lamp emitting infrared radiation.

In a further embodiment, each radiation source 22 is a laser diode emitting infrared radiation.

In other words, each radiation source is a laser (for example laser diodes) emitting in the infrared range and arranged by juxtaposition and superposition in order to form one or more matrices.

In particular, each matrix can be a matrix of vertical cavity surface emitting laser diodes (VCSEL), each diode emitting, for example, a laser beam having a unit power in the order of watts and having a wavelength of approximately 1 μm.

These radiation sources are radiant, i.e. the radiation emitted is transmitted to the preforms 2 without air being used as the transmission vector.

It goes without saying that each radiation source 22 could consist of any other radiation source without departing from the scope of the invention.

The heating unit 11 also comprises an electrical power supply 27 providing each radiation source 22 with electrical power. Each radiation source 22 thus converts the electrical power which is provided thereto into radiation heating the preforms.

The electrical power supply 27 makes it possible to switch on (or supply) or switch off each of the radiation sources 22 individually such that it is possible to control each of the radiation sources 22 and thus decide which will be used along the path for heating the preforms passing along in the heating unit 11. The distribution of the radiation sources switched on or switched off along the path and in the transverse direction is generally denoted by the term “mapping” (cartography) of the radiation sources as will be described in the remainder of the description.

The electrical power provided to the radiation sources 22 can also be variable between a maximum electrical power and a minimum effective electrical power of the radiation source 22. “Maximum electrical power” is understood to mean the maximum electrical power which can be applied to the radiation source 22 without it being damaged and “minimum effective electrical power” is understood to mean the minimum electrical power from which the radiation source 22 emits a radiation enabling a preform 2 to be heated.

The electrical power is directly expressed in power, i.e. in watts or as a percentage of the maximum electrical power of the radiation source 22.

As shown in FIGS. 1 and 2, the heating unit 11 comprises a control unit 28 which is connected to the electrical power supply 27.

The control unit 28 controls the electrical power supply 27 by means of power variators 26.

The power variators 26 enable the electrical power to be varied at the inlet of the radiation source 22 between the maximum electrical power and the effective minimum electrical power. These variators 26 can be analog or electronic.

The control unit 28 can advantageously control the electrical power supply or the electrical power supplies 27 and/or the variator or variators 26 of each radiation source 22.

As shown in FIGS. 1 and 2, the control unit 28 comprises a memory 30 in which at least one electrical power setpoint is stored for at least one row 24 of radiation sources 22 and at least one thickness setpoint in at least one point of the container 4.

Said setpoint values can be stored in the memory 30 of the control unit 28 by an operator.

The setpoint values are determined, for example, empirically on the basis of tests or from databases of previous preforms 2 which have been heated in order to obtain a container 4.

The control unit 28 uses at least one thickness measurement of a wall of the container 4 on at least one point by means of at least one sensor 32.

The sensor 32 for measuring the thickness is placed at the outlet of the molding unit 6 in order to measure at that point the thickness of the container 4 which has just been molded. In this embodiment, the sensor 32 is of the optical type. In a further embodiment, not shown, the sensor for measuring the thickness can be placed in the mold 10. In this case, the sensor can be of the capacitive type.

In order to obtain a good idea of the distribution of the material of the molded container 4, it is advantageous to position a plurality of sensors 32 at the height of the measured container.

For each container 4, the control unit 28 compares the thickness measurement obtained by means of a sensor with the corresponding stored thickness setpoint at the same height:

If the thickness measurement and the thickness setpoint are identical then the control unit 28 does not modify the electrical powers supplying the rows of radiation sources 24.

Conversely, if the measured thickness is different from the thickness setpoint, then the control unit 28 modifies the electrical power of at least two rows 24 of radiation sources, while keeping the sum of the electrical powers being supplied to all of the rows of radiation sources the same.

In other words, the electrical power is modified on a minimum of two rows 24 in order to be able to modify an electrical power on one row and to adjust the electrical power on at least one further row, and this makes it possible to keep the sum of the electrical powers on all of the rows the same.

In short, the rows 24 of radiation sources 22 are corrected and compensated so as to keep the sum of the electrical powers of the rows 24 the same before and after the modification.

More specifically, if the electrical power is only modified on a single row 24, then the control unit 28 will be unable to keep the sum of the electrical powers of all of the rows the same.

Advantageously, the control unit 28 modifies the electrical power of at least two rows 24 of radiation sources 22 in a homogenous manner. The term “homogenous” is understood to mean, for example, increasing the electrical power of a row by a certain value and reducing the electrical power of another row 24 by the same value and vice versa.

Advantageously, when the control unit 28 increases the electrical power on one row by a specific value, then the control unit reduces the electrical power on the remaining rows by the specific value, distributed over the remaining rows.

Advantageously, when the control unit 28 reduces the electrical power on a row 24 by a specific value, then the control unit increases the electrical power on the remaining rows by the specific value, divided by the number of remaining rows 24.

Moreover, these modifications to the electrical power are carried out gradually during the production of containers 4 in order to avoid a shutdown of the facility due to a non-uniform container.

FIG. 3 shows a schematic configuration of a unit 11 for heating preforms 3.

The schematic configuration shows a distribution of a certain number of rectangles symbolizing radiation sources 22 arranged side by side, i.e. in a row 24, and one on top of the other, i.e. in a column 34, and defining a matrix in this manner.

As shown in FIG. 3, in the matrix the rectangles can be three different colors according to the operating state of the radiation sources 22:
a white rectangle 36 signifies that the radiation source 22 is switched off, i.e. electrical power is not being supplied to the radiation source. As a result, this radiation source is not regulated;
a black rectangle 38 signifies that the radiation source 22 is switched on, i.e. 100% of the maximum electrical power for this type of radiation source is being supplied to the radiation source. As a result, this radiation source is not regulated;
a gray rectangle 40 signifies that the radiation source 22 is switched on, i.e. a power between a maximum electrical power and a minimum effective electrical power is being supplied to the radiation source. As a result, this radiation source 22 is regulated in terms of electrical power.

In the particular case shown in FIG. 3, the matrix of radiation sources 22 comprises 12 columns 34 and 8 rows 24 with a certain number of radiation sources switched off, switched on and regulated.

FIG. 3 shows a column of numbers on the left 42 of the matrix, corresponding to the sum of electrical powers (expressed as a percentage of the maximum power) being supplied to the radiation sources which are regulated and non-regulated for a given row.

FIG. 3 also shows a column of numbers on the right 44 of the matrix corresponding to the electrical power (expressed as a percentage of the maximum power) applied to each of the radiation sources regulated for the given row.

For example, for the row “8” shown in FIG. 3, all of the radiation sources 22 are switched off.

In a further example, for the row “1” shown in FIG. 3, the radiation sources 22 located in the columns 34:
1, 2, 3, 4 and 12 are switched off,
5, 6 are switched on with the maximum electrical power,
7, 8, 9, 10, 11 are regulated, each at 80% of the maximum power to which an overall percentage 46 of heating is applied (this overall percentage of heating making it possible to keep a temperature of the preform constant in spite of external interference, for example variations in the temperature of the factory). The sum of the electrical powers of the radiation sources forming the row is 45%.

Advantageously, on one row 24 of radiation sources 22, if at least one radiation source operates at its maximum electrical power 44, if the control unit requires an increase in power and if at least one radiation source 22 is switched off on the same row 24, then the control unit 28 switches on one of the radiation sources 22 which has been switched off and reduces the electrical power of each regulated radiation source of the row, while keeping the sum of the electrical powers being supplied to the row 24 of radiation sources constant.

Advantageously, on one row 24 of radiation sources 22, if at least one radiation source operates at a “minimum effective” electrical power, if the control unit requires a reduction in power then the control unit 28 switches off one of the regulated radiation sources and increases the electrical power of each radiation source 22 of the row 24, while keeping the sum of the electrical powers being supplied to the row 24 of radiation sources constant.

1. A method for producing containers made of thermoplastic material from preforms, which defines a path for circulating the preforms and the containers, comprises:
a molding unit for molding containers having a vertical axis comprising at least one blowing station, each including a mold with a cavity in the shape of a container and a device for injecting a pressurized fluid into the preform;
a heating unit for heating preforms which is located on the circulation path upstream of the molding unit relative to the direction of circulation of the preforms, comprising:
a means for conveying the preforms comprising a plurality of individual supports for the preforms defining a path for heating the preforms;
a heating cavity comprising two lateral walls that face one another and are at a distance from one another, at least one of said walls being that which bears a plurality of radiation sources arranged one above the other and side by side facing the preforms, thereby forming a row of radiation sources relative to the path for heating the preforms;
an electrical power supply, supplying each radiation source with electrical power;
a control unit connected to the electrical power supply, said control unit having a memory for storing:
at least one electrical power setpoint for at least one row of radiation sources;
at least one thickness setpoint in at least one point of the container;
said control unit carrying out at least one measurement of the thickness of a wall of the container at at least one point of the container by means of at least one sensor;
wherein the control unit
compares the thickness measurement with the stored thickness setpoint
and wherein, if the measured thickness is different from the thickness setpoint, then the control unit modifies the electrical power of at least two rows of radiation sources while keeping the sum of the electrical powers being supplied to all of the rows of radiation sources the same.

2. The method for producing containers as claimed in claim 1, wherein the control unit modifies said electrical power of at least two rows of radiation sources in a homogenous manner.

3. The method for producing containers as claimed in claim 2, wherein when the control unit increases the electrical power on a row by a specific value, then the control unit reduces the electrical power of the remaining rows by the specific value, divided by the number of remaining rows.

4. The method for producing containers as claimed in claim 2, wherein when the control unit reduces the electrical power on a row by a specific value, then the control unit increases the electrical power on the remaining rows by the specific value, divided by the number of remaining rows.

5. The method for producing containers as claimed in claim 1, wherein on one row of radiation sources, if at least one radiation source operates at its maximum electrical power and if at least one radiation source is switched off on the same row, then the control unit switches on one of the radiation sources which has been switched off and reduces the electrical power of each radiation source of the row, while keeping the sum of the electrical powers being supplied to the row of radiation sources constant.

6. The method for producing containers as claimed in claim 1, wherein on one row of radiation sources, if at least one radiation source operates at a “minimum effective” electrical power, then the control unit switches off one of the radiation sources and increases the electrical power of each radiation source of the row, while keeping the sum of the electrical powers being supplied the row of radiation sources constant.

7. The method for producing containers as claimed in claim 1, wherein the radiation sources are halogen lamps emitting in the infrared range.

8. The method for producing containers as claimed in claim 1, wherein the radiation sources are laser diodes emitting in the infrared range.

9. A computer program product comprising a sequence of instructions which, when the program is executed by a computer, results in the computer implementing the steps of the method as claimed in claim 1.

10. A data processing device comprising means for implementing the steps of the method as claimed in claim 1.

11. A computer program product comprising a sequence of instructions which, when the program is executed by a computer, results in the computer implementing the steps of the method as claimed in claim 2.

12. A computer program product comprising a sequence of instructions which, when the program is executed by a computer, results in the computer implementing the steps of the method as claimed in claim 3.

13. A computer program product comprising a sequence of instructions which, when the program is executed by a computer, results in the computer implementing the steps of the method as claimed in claim 4.

14. A computer program product comprising a sequence of instructions which, when the program is executed by a computer, results in the computer implementing the steps of the method as claimed in claim 5.

15. A computer program product comprising a sequence of instructions which, when the program is executed by a computer, results in the computer implementing the steps of the method as claimed in claim 6.

16. A computer program product comprising a sequence of instructions which, when the program is executed by a computer, results in the computer implementing the steps of the method as claimed in claim 7.

17. A computer program product comprising a sequence of instructions which, when the program is executed by a computer, results in the computer implementing the steps of the method as claimed in claim 8.

18. A method for producing containers made of thermoplastic material from preforms, defining a path for circulating the preforms and the containers and including a molding unit, a heating unit, a heating cavity, an electrical power supply, and a control unit, the molding unit configured for molding containers having a vertical axis comprising at least one blowing station, each including a mold with a cavity in the shape of a container and a device for injecting a pressurized fluid into the preform, the heating unit configured for heating preforms which is located on the circulation path upstream of the molding unit relative to the direction of circulation of the preforms, the heating unit comprising a means for conveying the preforms comprising a plurality of individual supports for the preforms defining a path for heating the preforms, the heating cavity comprising two lateral walls that face one another and are at a distance from one another, at least one of said walls being that which bears a plurality of radiation sources arranged one above the other and side by side facing the preforms, thereby forming a row of radiation sources relative to the path for heating the preforms, the electrical power supply configured for supplying each radiation source with electrical power, the control unit connected to the electrical power supply and having a memory for storing at least one electrical power setpoint for at least one row of radiation sources, at least one thickness setpoint in at least one point of the container, the control unit carrying out at least one measurement of the thickness of a wall of the container along at least one point of the container by means of at least one sensor, the method comprising:
comparing the thickness measurement with the stored thickness setpoint, by use of the control unit; and
modifying the electrical power of at least two rows of radiation sources while keeping the sum of the electrical powers being supplied to all of the rows of radiation sources the same, by use of the control unit, if the measured thickness is different from the thickness setpoint.
